(19) United States
(12) Patent Application Publication
(10) Pub. No.: US 2014/0225288 A1
(43) Pub. Date: Aug. 14, 2014

(54) MANUFACTURING METHOD FOR OPTICAL COMPENSATION FILM

(71) Applicants: Nobuyuki Haida, Ibaraki-shi (JP); Hironori Yaginuma, Ibaraki-shi (JP); Nao Murakami, Ibaraki-shi (JP); Motoko Kawasaki, Ibaraki-shi (JP); Kunihiro Seike, Kudamatsu-shi (JP); Keigo Ehara, Kudamatsu-shi (JP); Shogo Yamamoto, Kudamatsu-shi (JP)

(72) Inventors: Nobuyuki Haida, Ibaraki-shi (JP); Hironori Yaginuma, Ibaraki-shi (JP); Nao Murakami, Ibaraki-shi (JP); Motoko Kawasaki, Ibaraki-shi (JP); Kunihiro Seike, Kudamatsu-shi (JP); Keigo Ehara, Kudamatsu-shi (JP); Shogo Yamamoto, Kudamatsu-shi (JP)

(73) Assignees: TOYO KOHAN CO., LTD., Tokyo (JP); NITTO DENKO CORPORATION, Ibaraki-shi, Osaka (JP)

(21) Appl. No.: 14/233,499

(22) PCT Filed: Jul. 4, 2012
(86) PCT No.: PCT/JP2012/067042

§ 371 Date: Mar. 18, 2014

(30) Foreign Application Priority Data
Jul. 22, 2011 (JP) 2011-161210

(51) Int. Cl. G02B 5/30

(52) U.S. Cl. CPC G02B 5/3083
USPC 264/1.6

(57) ABSTRACT

A method for manufacturing a novel tilt alignment type optical compensation film formed using a non-liquid crystal polymer material, instead of a conventional tilt alignment type optical compensation film using a liquid crystal material. The method for manufacturing including: melting a non-liquid crystal polymer to prepare a molten resin; applying a shear force to the melted non-liquid crystal polymer by a shear force application device, thereby forming a film having an optical axis that tilts with respect to a thickness direction of the film; and stretching the film. The step of forming the film is carried out under conditions where a temperature T3 of the melted non-liquid crystal polymer, a glass transition point Tg of the non-liquid crystal polymer, and a temperature T2 of the shear force application device satisfy relationships represented by the following formulae (A) and (B):

T3>Tg+25° C.; and (A)

T3>T2. (B)

### TECHNICAL FIELD

The present invention relates to a method for manufacturing an optical compensation film.

### BACKGROUND ART

Heretofore, when liquid crystal displays (LCDs) are seen from oblique directions, decrease in contrast and change in hue occur. Thus, the viewing angle characteristics of the liquid crystal displays are not sufficient as compared with those of CRTs, and improvement thereof has been strongly demanded. A main factor determining the viewing angle characteristics of an LCD is the angle dependence of the birefringence of a liquid crystal cell. For example, a twisted nematic (TM mode liquid crystal display is excellent in response speed and contrast, and also achieves high productivity. Thus, the TN mode liquid crystal display is used widely as display means in various devices, including office automation equipment such as personal computers and monitors. However, in the TN mode liquid crystal display, liquid crystal molecules are aligned so as to tilt with respect to electrode substrates provided above and below the liquid crystal molecules. Thus, depending on an angle at which a display image is observed, the contrast of the display image changes and the screen is colored to cause the deterioration in visibility etc., resulting in a problem of high degree of viewing angle dependence. On this account, it has been strongly desired to improve the viewing angle characteristics by compensating the angle dependence of this birefringence, i.e., retardation, with the use of an optical compensation film.

In order to improve the viewing angle characteristics, in the TN mode liquid crystal display, a tilt alignment type optical compensation film is used, for example. For example, there have been reported: an optical compensation film that contains low-molecular liquid crystals in a tilt alignment state in a polymer matrix (see Patent Document 1, for example); and an optical compensation film obtained by forming an alignment film on a support, aligning discotic liquid crystals so as to tilt, on the alignment film, and then polymerizing the liquid crystals (see Patent Document 2, for example). However, although many kinds of optical compensation films for use in the TN mode obtained by aligning a liquid crystal material so as to tilt as described above, they have problems in that, for example: the manufacturing process therefor is complicated because it is necessary to select a liquid crystal material (e.g., selection of a liquid crystal material for which tilt alignment can be caused easily utilizing the difference in surface energy at an interface with air) and to control the tilt angle of the liquid crystal material (e.g., control of the tilt angle with a surfactant) and also because an alignment substrate is essential; and it is difficult to change the tilt angle and retardation because there are various factors that need to be controlled (see Patent Document 3, for example).

Furthermore, when a liquid crystal material is used, it is difficult to control every single liquid crystal molecule precisely. Thus, the alignment of the liquid crystal molecules forming a film as a whole may not be uniform, which may cause depolarization of polarized light, resulting in decrease in panel contrast.

Moreover, unlike a VA mode liquid crystal display or an IPS mode liquid crystal display, the TN mode liquid crystal display is configured so that, because of its nature, a polarizing plate is arranged in such a manner that the absorption axis of a polarizer tilts at 45° or 135° with respect to the transverse direction of a liquid crystal panel. If the size of the polarizing plate changes when it is subjected to a high or low temperature environment or to a high humidity environment, a stress may be applied to the optical compensation film, thus causing distortion in the film. Owing to this distortion, light leakage occurs to cause variations in luminance in the horizontal direction and the vertical direction of the liquid crystal panel, resulting in a problem of uniformity in appearance.

### CITATION LIST

### Patent Document(s)

Patent Document 1: Japanese Patent No. 2565644

Patent Document 2: Japanese Patent No. 2802719

Patent Document 3: JP 2000-105315 A

### BRIEF SUMMARY OF THE INVENTION

### Problem to be Solved by the Invention

It is an object of the present invention to provide a method for manufacturing, instead of a conventional tilt alignment type optical compensation film formed using a liquid crystal material, a novel tilt alignment type optical compensation film formed using a non-liquid crystal polymer material. More specifically, it is an object of the present invention to provide a method for manufacturing a tilt alignment, type optical compensation film that is formed using a non-liquid crystal polymer material and useful in improving the viewing angle characteristics of TN mode liquid crystal displays etc., for example.

### Means for Solving Problem

In order to achieve the above object, the present invention provides a method for manufacturing an optical compensation film that contains a non-liquid crystal polymer, including the steps of melting the non-liquid crystal polymer to prepare a molten resin; applying a shear force to the melted non-liquid crystal polymer by a shear force application device, thereby forming a film having an optical axis that tilts with respect to a thickness direction of the film; and stretching the film. In this method, the step of forming the film is carried out under conditions where a temperature T3 of the melted non-liquid crystal polymer, a glass transition point. Tg of the non-liquid crystal polymer, and a temperature T2 of the shear force application device satisfy relationships represented by the following formulae (A) and (B):

T3>Tg+25° C.; and (A)

T3>T2. (B)

### Effects of the Invention

According to the present invention, it is possible to provide a method for manufacturing a novel tilt alignment type optical compensation film that is formed using a non-liquid crystal polymer material, instead of a conventional tilt alignment type optical compensation film using a liquid crystal material.

### BRIEF DESCRIPTION OF DRAWINGS

FIGS. 1A and 1B are schematic views for explaining an average tilt angle.

FIGS. 2A to 2D show examples of the film-forming step of the present invention.

FIG. 3 is a schematic sectional view showing an example of the structure of an optical compensation film-integrated polarizing plate provided by the present invention.

FIG. 4 is a schematic sectional view showing an example of the structure of a liquid crystal panel provided by the present invention.

FIG. 5A is a photograph showing the uniformity in appearance of a liquid crystal display of Example 3 FIG. 5B is a photograph showing the uniformity in appearance of a liquid crystal display of Example 0.4; and FIG. 5C is a photograph showing the uniformity in appearance of a liquid crystal display of Comparative Example 1.

### DETAILED DESCRIPTION OF THE INVENTION

In the manufacturing method of the present invention, it is preferable that, in the step of forming the film, the shear force is applied to the melted non-liquid crystal polymer by causing the melted non-liquid crystal polymer to pass between two rolls rotated at different rotational speeds, and T2 is a temperature of one of the two rolls having a higher temperature.

In the manufacturing method of the present invention, it is preferable that the ratio of the rotational speed of one of the two rolls to the rotational speed of the other roll is in the range from 0.1% to 50%.

In the manufacturing method of the present invention, it is preferable that T2 satisfies a relationship represented by Tg−70° C.<T2<Tg+15° C. When T2 satisfies this relationship, the tilt of the optical axis of the optical compensation film is sufficient, so that problems such as increase in in-plane retardation Re and poor appearance are not caused.

In the manufacturing method of the present invention, it is preferable that a stretching temperature T4 in the step of stretching the film satisfies a relationship represented by Tg≦T4<T3. When T4 satisfies this relationship, the tilt of the optical axis of the optical compensation film is sufficient.

In the manufacturing method of the present invention, it is preferable that, in the step of stretching the film, the film is stretched at a stretch ratio in the range from 1.01 to 2.00 times.

In the manufacturing method of the present invention, it is preferable that the optical compensation film satisfies the following formulae (1) and (2).

3 nm≦(nx−ny)×d≦200 nm (1)

5°<β (2)

(In the formulae (1) and (2), among three refractive indices nx, ny, and nz respectively on X, Y, and Z, nx denotes a refractive index in a direction in which a refractive index within a film plane reaches its maximum ny denotes a refractive index in a direction that is orthogonal to the direction of nx within the film plane; and nz denotes a refractive index in a thickness direction of the film, which is orthogonal to each of the directions of nx and lay, and d denotes a thickness (nm) of the film, and β denotes an angle formed by a direction of nb and the direction of ny, where nb is a maximum refractive index within in YZ plane of the film, which is orthogonal to the direction of nx.)

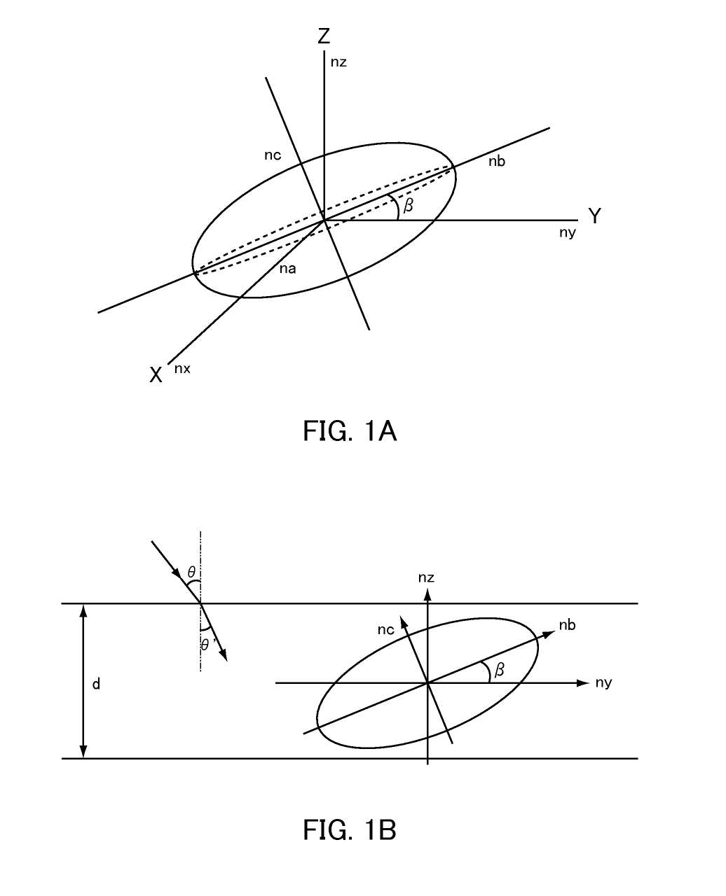

In the present invention, “β” denotes an average tilt angle, which means a statistically-averaged tilt alignment angle of all molecules (e.g., non-liquid crystal polymer molecules). Specifically, the average tilt angle “β” means an average tilt alignment angle of all the molecules present in the thickness direction (molecules in the bulk state), and as shown in FIGS. 1A and 1B, it is an angle formed by the nb direction and the ny direction.

Next, the method for determining the average tilt angle “β” will be described. As shown in FIG. 1B, assuming that the tilts of molecules in the film thickness direction as averaged form a single index ellipsoid, a retardation value δ to be measured with respect to light incident, at a certain angle θ is represented by the following formula (I). Thus, for example, the average tilt angle “β” can be calculated according to the following formulae (I) and (II) using retardation values measured at 5°-interval in the polar angle range from −60° to +60°(with the normal direction being 0°) in a direction perpendicular to the slow axis. In the formulae (I) and (II), na, nb, and no are refractive indices of components of the film themselves. More specifically, they are refractive indices nx ny and nz of the film when β is 0, and d is the thickness (nm) of the film.

$$\begin{matrix}δ = \frac{d}{cos {θ}^{′}} ( \frac{nb nc}{\sqrt{{nb}^{2} {sin}^{2} ( {θ}^{′} - β ) + {nc}^{2} {cos}^{2} ( {θ}^{′} - β )}} - na ) & ( I ) \\ {θ}^{′} = arcsin ( \frac{sin θ}{( na + nb + nc ) \text{/} 3} ) & ( II )\end{matrix}$$

Next, the method for manufacturing an optical compensation film according to the present invention will be described below with reference to an illustrative example. As described above, the manufacturing method of the present invention includes a series of steps, namely, the melting step, the film-forming step, and the stretching step.

(1) Melting Step

First, a molten resin is prepared by melting a non-liquid crystal polymer.

The molten resin may be formed of a thermoplastic resin containing a non-liquid crystal polymer, or may be a mixture of a non-liquid crystal polymer with any other thermoplastic resin. Any appropriate thermoplastic resin containing a non-liquid crystal polymer can be used and it is preferable to use a molten resin that can form a transparent film with a light transmittance of at least 70%. Also, it is preferable that the molten resin has a glass transition point (Tg) from 80° C. to 170° C., a melting temperature from 180° C. to 300° C., and a melt viscosity at a shear rate of 100 (1/s) of not more than 10000 Pa·s at 250° C. Such a molten resin can be formed into a film easily. Thus, by using such a molten resin, it is possible to obtain an optical compensation film with high transparency by a general forming method such as extrusion, for example. Also, by selecting a non-liquid crystal polymer having a photoelastic coefficient from 1×10⁻¹² to 9×10⁻¹¹ m²/N as the non-liquid crystal polymer, it is possible to obtain an optical compensation film with a preferable photoelastic coefficient (1×10⁻¹² to 9×10⁻¹¹ m²/N). In a conventional tilt alignment type optical compensation film formed using a liquid crystal material (e.g., “WV FILM (trade name)” manufactured by FUJIFILM Corporation), a support base is essential, and because the support base and the liquid crystal material each have a large, photoelastic coefficient, a problem occurs regarding the uniformity in appearance. In contrast, according to the optical compensation film obtained by the present invention, light leakage and variations in luminance can be prevented from occurring even when the film is subjected to a stress owing to the change in size of a polarizing plate etc. As a result, by using the optical compensation film obtained by the present invention, it is possible to obtain a TN mode liquid crystal panel or liquid crystal display excellent in uniformity in appearance, for example. Furthermore, as compared with the conventional tilt alignment type optical compensation film using a liquid crystal material, the optical compensation film obtained by the present invention causes a smaller degree of depolarization when the optical compensation film is integrated with a polarizer, so that higher polarization can be achieved. As a result, by using the optical compensation film obtained by the present invention, it is possible to obtain a TN mode liquid crystal panel or liquid crystal display excellent in front contrast, for example. Moreover, because the optical compensation film obtained by the present invention contains a non-liquid crystal polymer; it can be used suitably as a protective film for a polarizer, for example.

Examples of the non-liquid crystal polymer include acrylic polymers, methacrylic polymers, styrene polymers, olefin polymers, cyclic olefin polymers, polyallylate polymers, polycarbonate polymers, polysulfone polymers, polyurethane polymers, polyimide polymers, polyester polymers, polyvinyl alcohol polymers, and copolymers thereof. Also, cellulose polymers and polyvinyl chloride polymers such as poly chloride can be used preferably as the non-liquid crystal polymer. Only one kind of these non-liquid crystal polymers may be used, or two or more kinds of them may be used in combination. Among them, acrylic polymers, methacrylic polymers, olefin polymers, cyclic olefin polymers, polyallylate polymers, polycarbonate polymers, polyurethane polymers, and polyester polymers are preferable. These non-liquid crystal polymers are excellent in transparency and alignment property. Therefore, by using any of these non-liquid crystal polymers, it is possible to obtain an optical compensation film having a preferable birefringence (in-plane alignment Δn. The birefringence Δn preferably is in the range from 0.0001 to 0.02 at a wavelength of 590 nm. Generally, the birefringence Δn of a liquid crystal cell and the birefringence Δn of an optical compensation film have wavelength dependence. However, when the birefringence Δn of the optical compensation film is in the above range, the wavelength dependence of the birefringence Δn of the optical compensation film can be synchronized with the wavelength dependence of the birefringence Δn of the liquid crystal cell. As a result, for example, in a TN mode liquid crystal panel or liquid crystal display, change in birefringence Δn and phase shift depending on the viewing angle can be reduced over the entire wavelength region of visible light, so that the occurrence of the coloration phenomenon can be prevented. More preferably, the birefringence Δn of the optical compensation film is from 0.0001 to 0.018. The birefringence Δn can be calculated according to the formula: Δn=nx−nz. The above-described effect can be exhibited more efficiently when the ratio of the birefringence Δn at a wavelength of 450 nm to the birefringence Δn at a wavelength of 550 nm (Δn450/Δn550) preferably is from 0.80 to 1.2, more preferably from 0.90 to 1.15. As a result, a high degree of compensation can be realized over a wide range of viewing angle, whereby a viewing angle compensating effect can be obtained to provide a favorable contrast, for example. In general, the in-plane alignment property and the tilt alignment property are in a trade-off relationship. However, by selecting a non-liquid crystal polymer having the above-described properties, it is possible to form an optical compensation film by achieving tilt alignment while maintaining a high in-plane alignment, property.

Examples of the acrylic polymers include polymers obtained by polymerizing an acrylate monomer such as methyl acrylate, butyl acrylate, or cyclohexyl acrylate. Examples of the methacrylic polymers include polymers obtained by polymerizing a methacrylate monomer such as methyl methacrylate, butyl methacrylate or cyclohexyl methacrylate. Among them, polymethyl methacrylate is preferable.

Examples of the olefin polymers include polyethylene and polypropylene.

The cyclic olefin polymer is a general term for resins obtained by polymerization of a cyclic olefin as a polymerization unit, and examples thereof include resins described in JP 1(1989)-240517A, JP 3(1991)-14882 A, and JP 3(1991)-122137 A. The cyclic olefin polymer may be a copolymer of a cyclic olefin and any other monomer. Specific examples of the cyclic olefin polymer include: ring-opening (co)polymers of a cyclic olefin; addition polymer of a cyclic olefin; copolymers (typically random copolymers) of a cyclic olefin with α-olefin such as ethylene or propylene; graft denaturation products obtained by denaturing them with an unsaturated carboxylic acid or a derivative thereof; and hydrides thereof. Specific examples of the cyclic olefin include norbornene monomers.

Examples of the norbornene monomer include: norbornene and alkyl- and/or alkylidene-substitution products thereof (e.g., 5-methyl-2-norbornene 5-dimethyl-2-norbornene, 5-ethyl-2-norbornene, 5-butyl-2-norbornene, and 5-ethylidene-2-norbornene, and substitution products thereof with a polar group such as a halogen); dicyclopentadiene and 2,3-dihydrodicyclopentadiene; dimethanooctahydronaphthalene, alkyl- and/or alkylidene-substituted products thereof, and substitution products thereof with a polar group such as a halogen (e.g., 6-methyl-1,4:5,8-dimethano-1,4,4a,5,6,7,8,8a-octahydronaphthalene, 6-ethyl-1,4:5,8-dimethano-1,4,4a,5,6,7,8,8a-octahydronaphthalene, 6-ethylidene-1,4:5,8-dimethano-1,4,4a,5,6,7,8,8a-octahydronaphthalene, 6-chloro-1,4:5,8-dimethano-1,4,4a,5,6,7,8,8a-octahydronaphthalene, 6-cyano-1,4:5,8-dimethano-1,4,4a,5,6,7,8,8a-octahydronaphthalene, 6-pyridyl-1,4:5,8-dimethano-1,4,4a,5,6,7,8,8a-octahydronaphthalene, 6-methoxycarbonyl-1,4:5,8-dimethano-1,4,4a,5,6,7,8,8a-octahydronaphthalen e); trimers and tetramers of cyclopentadiene (e.g., 4,9:5,8-dimethano-3a,44a,5,8,8a9,9a-octahydro-1H-benzoindene, 4,11:5,10:6,9-trimethano-3a,4,4a,5,5a,6,9,9a,10,10a,11,11a-dodecahydro-1H-cy clopentaanthracene, etc). The cyclic olefin polymer may be a copolymer of the norbornene monomer and any other monomer.

As the polycarbonate polymer, an aromatic polycarbonate preferably is used. The aromatic polycarbonate can be obtained typically by a reaction of a carbonate precursor with an aromatic divalent phenol compound. Specific examples of the carbonate precursor include: phosgene, bischloroformates of divalent phenols, diphenylcarbonates, di-p-tolyl carbonates, phenyl-p-tolyl carbonates, di-p-chlorophenyl carbonates, and dinaphthyl carbonates. Among them, phosgene and diphenylcarbonates are preferable. Specific examples of the aromatic divalent phenol compound include 2,2-bis(4-hydroxyphenyl)propane, 2,2-bis(4-hydroxy-3,5-dimethylphenyl)propane, bis(4-hydroxyphenyl)methane, 1,1-bis(4-hydroxyphenyl)ethane, 2,2-bis(4-hydroxyphenyl)butane, 2,2-bis(4-hydroxy-3,5-dimethylphenyl)butane, 2,2-bis(4-hydroxy-3,5-dipropylphenyl)propane, 1,1-bis(4-hydroxyphenyl)cyclohexane and 1,1-bis(4-hydroxyphenyl)-3,3,5-trimethylcyclohexane. Only one kind of these compounds may be used, or two or more kinds of them may be used in combination. It is preferable to use 2,2-bis(4-hydroxyphenyl)propane, 1,1-bis(4-hydroxyphenyl)cyclohexane or 1,1-bis(4-hydroxyphenyl)-3,3,5-trimethylcyclohexane. In particular it is preferable to use 2,2-bis(4-hydroxyphenyl)propane and 1,1-bis(4-hydroxyphenyl)-3,3,5-trimethylcyclohexane in combination.

Examples of the polyurethane polymers include polyester polyurethanes (denatured polyesterurethanes, water-dispersible polyesterurethanes, and solvent-soluble polyesterurethanes), polyether polyurethanes, and polycarbonate polyurethanes.

Preferable examples of the polyester polymers include polyethylene terephthalate and polybutylene terephthalate.

In the present step, when the non-liquid crystal polymer is an amorphous resin, it is preferable to prepare the molten resin by melt-extruding the non-liquid crystal polymer at a temperature equal to or higher than the glass transition point Tg of the non-liquid crystal polymer+80° C. When the non-liquid crystal polymer is a crystalline resin, it is preferable to prepare the molten resin by melt-extruding the non-liquid crystal polymer at a temperature equal to or higher than the melting point of the non-liquid crystal polymer. The melt extrusion can be performed, for example, using conventionally known melt extrusion means such as a T-die.

(2) Film-Forming Step

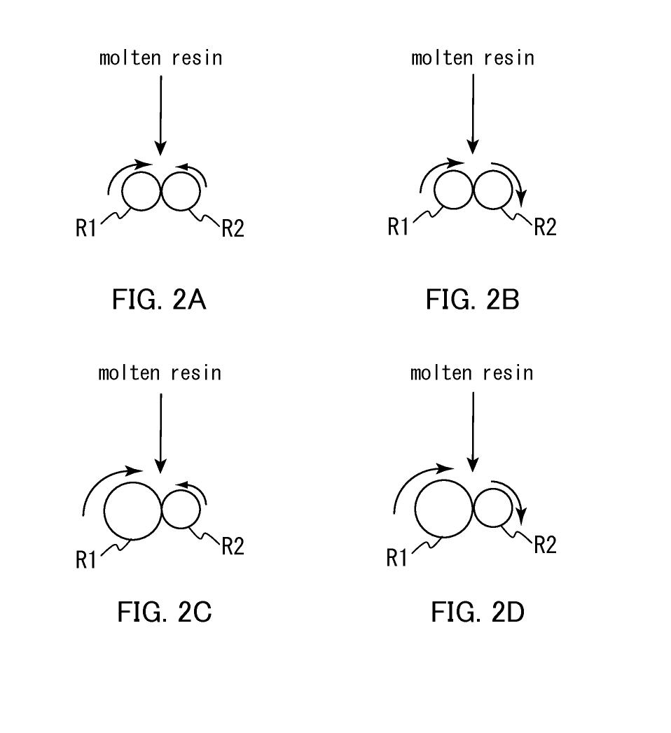

Next, a shear force is applied to the melted non-liquid crystal polymer by a shear force application device to form a film having an optical axis that tilts with respect to the thickness direction. FIG. 2 shows examples of the present step. In the present step, for example, as shown in FIG. 2A, the molten resin is passed between two rolls R1 and R2 rotated at different rotational speeds and in different rotational directions to apply a shear force to the molten resin, thereby forming the molten resin into a film. The ratio of the rotational speed of one of the two rolls to the rotational speed of the other roll is as described above. In the present step, as shown in FIG. 2B, the molten resin may be formed into a film by passing the molten resin between two rolls R1 and R2 rotated at the same rotational speed and also in the same rotational direction (in the present example, both the rolls are rotated to the right) to apply a shear force to the molten resin. The two rolls R1 and R2 may have different diameters, as shown in FIGS. 2C and 2D.

As described above, in the present, step, the temperature T3 of the molten resin and the glass transition point Tg of the thermoplastic resin satisfies the relationship represented by T3>Tg+25° C. Also, in the present step, the temperature T2 of the shear force application device (e.g., among the two rolls, the one having a higher temperature) and T3 satisfies the relationship represented by T3>T2. When the relationship represented by T3>Tg+25° C. is satisfied and also the relationship represented by T3>T2 is satisfied, it is possible to prevent, the occurrence of poor appearance, such as stripes, caused by the optical compensation film in a liquid crystal display etc.

As described above, it is preferable that T2 satisfies the relationship represented by Tg−70′C<T2<Tg+15° C. and the reason therefor is as described above.

T2 satisfies the relationship represented by T1>T2, where T1 denotes the temperature of the molten resin during the melt extrusion in the melting step. Also, it is preferable that T3 satisfies the relationship represented by T1>T3. When this relationship is satisfied, the tilt, of the optical axis of the optical compensation film is sufficient, so that the increase in the in-plane retardation Re does not occur. It is more preferable that T3 satisfies the relationship represented by T1>T3×1.1.

(3) Stretching Step

Next, the film is stretched. The stretching direction may be the width direction of the film, or may be the longitudinal direction of the film. The stretching method and stretching conditions (the stretching temperature and the stretch ratio) can be selected as appropriate depending on the kind of the non-liquid crystal polymer, desired optical characteristics, etc. However, as described above, it is preferable that the stretching temperature T4 in the present step satisfies the relationship represented by Tg≦T4<T3, and the reason therefor is the same as described above. Furthermore, as described above, in the present step, the stretch ratio preferably is in the range from 1,01 to 2.00 times.

As described above, the manufacturing method according to the present invention does not require a complicated treatment for achieving tilt alignment. Furthermore, after the tilt alignment is achieved, the optical characteristics can be controlled easily so as to achieve a desired retardation through a treatment such as stretching or shrinkage. In a conventional tilt alignment type optical compensation film formed using a liquid crystal material, such retardation control after the tilt alignment is not possible. Thus, this is one of advantageous points of the optical compensation film obtained by the present invention. Furthermore, because alignment can be achieved by a general stretching treatment, a high degree of freedom can be offered for the setting of the thickness and width of the film. As a result, an optical compensation film with desired optical characteristics can be designed at low cost.

The thickness of the optical compensation film obtained by the present invention can be set to any appropriate value. The thickness preferably is from 10 to 300 μm, more preferably from 20 to 200 μm.

Preferably the refractive indices of the optical compensation film obtained by the present invention satisfy the relationship represented by nx>ny>nz or nx>ny=nz. It is to be noted here that “ny=nz” not only means that ny and nz are exactly equal but also encompasses the case where ny and nz are substantially equal and the Nz coefficient is more than 0.9 and less than 1.1. When the refractive indices of the optical compensation film obtained by the present invention satisfy the relationship represented by nx>ny>nz, the Nz coefficient of the optical compensation film preferably is in the range from 1.1 to 10, more preferably from 1.1 to 8. When the refractive indices satisfy this relationship, the optical compensation film obtained by the present invention can achieve suitable viewing angle compensation in all the directions in a liquid crystal cell that serves as a tilt alignment type retardation plate having positive biaxial anisotropy with the alignment of the respective liquid crystal molecules being assumed as an integrated retardation, for example. As such a liquid crystal cell, a TN mode liquid crystal cell is particularly preferable. The Nz coefficient can be calculated according to the formula: Nz coefficient=Rth/Re. Re denotes an in-plane retardation of the optical compensation film at 23° C. and at a wavelength of 590 nm, for example, and can be determined according to the formula: Re=(nx−ny)×d, where d is the thickness (nm) of the optical compensation film. Rth denotes the retardation in the thickness direction of the optical compensation film at 23° C. and at a wavelength of 590 nm, for example, and can be determined according to the formula: Rth=(nx−nz)×d, where d is the thickness (nm) of the optical compensation film.

The optical compensation film obtained by the present invention may have two optical axes in a plane that is not parallel to any of the X-Y plane, Y-Z plane, and Z-X plane of the film (i.e., a plane that includes the nb direction and the ox direction). Such an optical compensation film can have, as an alignment axis, a maximum refractive index nx (na) in a direction perpendicular to the tilt direction (nb direction) of the non-liquid crystal polymer. The direction of the alignment axis of the optical compensation film can be made perpendicular to the tilt, direction by aligning a non-liquid crystal polymer that exhibits negative biaxial refractive index anisotropy so as to tilt at a predetermined angle, for example. Such an optical compensation film can perform viewing angle compensation of a liquid crystal panel or liquid crystal display of TN mode or the like more suitably.

(4) Use

Next, the use of the optical compensation film obtained by the present invention will be described with reference to illustrative examples. It is to be noted, however, that the uses to be described below are merely illustrative, and do not limit the present invention by any means.

(4-1) Optical Compensation Film-Integrated Polarizing Plate

The optical compensation film obtained by the present invention can be used in an optical compensation film-integrated polarizing plate, for example. The optical compensation film-integrated polarizing plate includes the optical compensation film obtained by the present invention and a polarizer. The optical compensation film obtained by the present invention causes a smaller degree of depolarization as compared with conventional tilt alignment type optical compensation films using a liquid crystal material, so that higher polarization can be achieved when the optical compensation film obtained by the present invention is laminated on a polarizer.

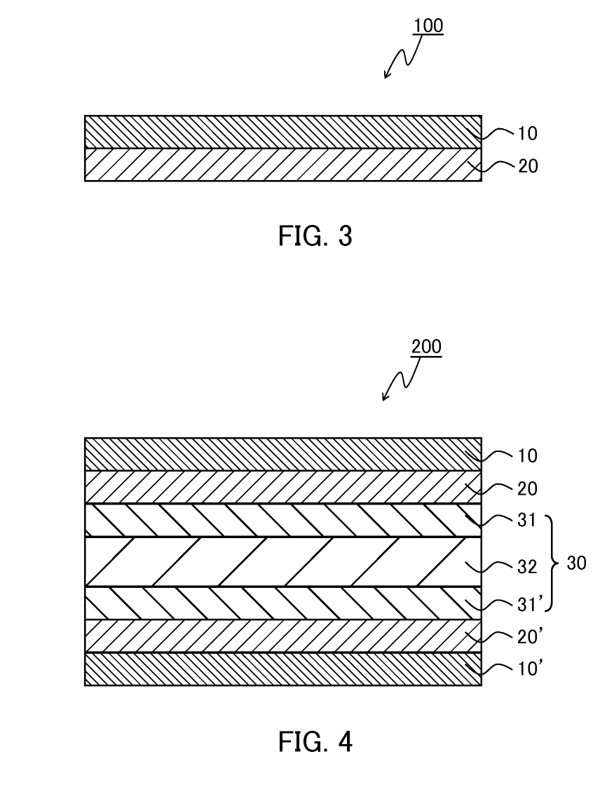

FIG. 3 shows an example of the structure of the optical compensation film-integrated polarizing plate. As shown in FIG. 3, this optical compensation film-integrated polarizing plate 100 includes a polarizer 10 and an optical compensation film 20 obtained by the present invention. In the optical compensation film-integrated polarizing plate 100, any appropriate protective film (not shown) may be provided between the polarizer 10 and the optical compensation film 20 and/or on the side of the polarizer 10 where the optical compensation film 20 is not provided, if it is necessary. The respective layers included in the optical compensation film-integrated polarizing plate 100 are arranged via any appropriate pressure-sensitive adhesive layer or adhesive layer (not shown). In the case where a protective film is not provided between the polarizer 10 and the optical compensation film 20, the optical compensation film 20 also can serve as a protective film for the polarizer 10.

The polarizer 10 and the optical compensation film 20 are laminated in such a manner that the absorption axis of the polarizer 10 and the slow axis of the optical compensation film 20 form any appropriate angle. In the case where the optical compensation film-integrated polarizing plate 100 is used in a TN mode liquid crystal panel or liquid crystal display, it is preferable that the polarizer 10 and the optical compensation film 20 are laminated so that the absorption axis of the polarizer 10 and the slow axis of the optical compensation film 20 are substantially orthogonal to each other. The term “substantially orthogonal” as used herein also encompasses the deviation within the range from 90°±3°, preferably from 90°±1°.

As the polarizer, any appropriate polarizer can be employed depending on the intended use of the polarizer. The polarizer may be, for example: a film obtained by allowing a hydrophilic polymer film such as a polyvinyl alcohol film, a partially formalized polyvinyl alcohol film, or a partially-saponified film based on an ethylene-vinyl acetate copolymer to adsorb a dichroic substance such as iodine or a dichroic dye and then uniaxially stretching the film; or an alignment film based on polyene such as dehydrated polyvinyl alcohol or dehydrochlorinated polyvinyl chloride. Among them, a polarizer obtained by allowing a polyvinyl alcohol film to adsorb iodine and then uniaxially stretching the film is particularly preferable, because it exhibits a high polarization dichroic ratio. The thickness of the polarizer is not particularly limited, and may be in the range from 1 to 80 μm, for example.

The polarizer obtained by allowing a polyvinyl alcohol film to adsorb iodine and then uniaxially stretching the film can be prepared by, for example, dyeing the polyvinyl alcohol film with iodine by immersing it in an aqueous solution of iodine and then stretching the film to 3 to 7 times its original length. If necessary, the polyvinyl alcohol film may be immersed also in an aqueous solution containing boric acid, zinc sulfate, zinc chloride, or the like, or may be immersed in an aqueous solution of potassium iodide or the like. Furthermore, if necessary, before dyeing the film, the polyvinyl alcohol film may be washed with water by immersing it in water.

By washing the polyvinyl alcohol film with water, dirt and an anti-blocking agent on surfaces of the polyvinyl alcohol film can be removed. In addition, this brings about another effect that it swells the polyvinyl alcohol film, thereby preventing nonuniformity such as unevenness in dyeing. The polyvinyl alcohol film may be stretched after it has been dyed with iodine, or it may be stretched while being dyed with iodine. Alternatively, the polyvinyl alcohol film may be stretched first and then dyed with iodine. The polyvinyl alcohol film can be stretched in an aqueous solution of boric acid, potassium iodide, or the like, or in a water bath.

(4-2) Liquid Crystal Display

The optical compensation film obtained by the present invention can be used in a liquid crystal display, for example. The liquid crystal display includes: a liquid crystal cell; and the optical compensation film obtained by the present invention or an optical compensation film-integrated polarizing plate provided by the present invention, arranged on at least one side of the liquid crystal cell. FIG. 4 shows an example of the structure of a liquid crystal panel included in a liquid crystal display provided by the present invention. As shown in FIG. 4, this liquid crystal panel 200 includes: a liquid crystal cell 30; optical compensation films 20 and 20′ arranged on the respective sides of the liquid crystal cell 30; and polarizers 10 and 10′ arranged on the side opposite to the liquid crystal cell 30 on the respective optical compensation films 20 and 20′. At least one of the optical compensation films 20 and 20′ is the optical compensation film obtained by the present invention. The polarizers 10 and 10′ typically are arranged so that their absorption axes are orthogonal to each other. Depending on the intended use of the liquid crystal display and the alignment mode of the liquid crystal cell, one of the optical compensation films 20 and 20′ may be omitted. Furthermore, as the optical compensation film 20 (20′) and the polarizer 10 (10′), the optical compensation film-integrated polarizing plate provided by the present invention preferably is used.

The liquid crystal cell 30 includes: a pair of glass substrates 31 and 31′; and a liquid crystal layer 32, which serves as a display medium, arranged between the substrates 31 and 31′. One of the substrates, namely, the substrate (active matrix substrate) 31′ is provided with a switching element (typically a TFT) for controlling the electro-optical characteristics of liquid crystal and a scanning line for supplying a gate signal and a signal line for transmitting a source signal to this switching element (both not shown). The other substrate (color filter substrate) 31 is provided with a color filter (not shown). The color filter may be provided on the active matrix substrate 31′. The distance between the substrates 31 and 31′ (the cell gap) is controlled by a spacer (not shown). On the side of each of the substrates 31 and 31′ that is in contact with the liquid crystal layer 32, an alignment film (not shown) formed of, e.g., polyimide is provided.

As the driving mode of the liquid crystal cell, any appropriate driving mode can be employed. Preferably, the driving mode is a TN mode, a bend nematic (OCB) mode, or an electrically controlled birefringence (ECB) mode. Among them, the TN mode is particularly preferable. This is because, when the above-described optical compensation film or optical compensation film-integrated polarizing plate is used in combination with a TN mode liquid crystal cell, an excellent viewing angle-improving effect can be obtained.

The TN mode liquid crystal cell is a liquid crystal cell in which a nematic liquid crystal exhibiting positive dielectric anisotropy is sandwiched between two substrates, and the alignment of the liquid crystal molecules is twisted 90° by subjecting the glass substrates to a surface alignment treatment. Specific examples of the TN mode liquid crystal cell include: a liquid crystal cell described on page 158 of “Ekisho Jiten” published by Baifukan Co., Ltd. (1989) and a liquid crystal cell described in JP 0.63(1988)-279229 A.

The OCB (Optically Compensated Bend or Optically Compensated Birefringence) mode liquid crystal cell is a liquid crystal cell in which a nematic liquid crystal exhibiting positive dielectric anisotropy is present between transparent electrodes, and the nematic liquid crystal is in a bend alignment state having twisted alignment in a central part, in the absence of voltage application, by utilizing an ECB (Electrically Controlled Birefringence) effect. The OCB mode liquid crystal cell also is referred to as a “π cell”. Specific examples of the OCB mode liquid crystal cell include: a liquid crystal cell described on pages 11 to 27 of “Jisedai Ekisho Display” (2000) published by Kvoritsu Shuppan Co., Ltd.,; and a liquid crystal cell described in JP 7(1995)-084254 A.

In the ECB mode, liquid crystal molecules in the liquid crystal cell are aligned in a predetermined direction in the absence of voltage application. When a voltage is applied, the liquid crystal molecules tilt at a predetermined angle with respect to the predetermined direction, thereby changing the polarizing state for display based on the birefringence effect. Furthermore, in the ECB mode, the tilt of the liquid crystal molecules is changed depending on the level of the applied voltage, and depending on the tilt of liquid crystal molecules, the intensity of transmitted light is changed. Thus, when white light is caused to enter the liquid crystal cell, light, passing through an analyzer (a polarizer located on the visible side) is colored by an interference phenomenon, and the hue of the colored light is changed depending on the tilt of the liquid crystal molecules (the level of the applied voltage). As a result, the ECB mode is advantageous in that it can achieve color display with a simple structure (e.g., without a color filter). In the present invention, as long as the driving mechanism (the display mechanism) as described above is provided, any suitable ECB mode can be employed. Specific examples thereof include a homeotropic (DAP: Deformation of Vertically Aligned Phases) mode, a homogeneous mode, and a hybrid (HAN: Hybrid Aligned Nematic) mode.

The use of the liquid crystal display is not particularly limited. The liquid crystal display is applicable to various kinds of use, examples of which include: office automation equipment such as monitors of personal computers, notebook-size personal computers, and copy machines; portable devices such as mobile phones, watches, digital cameras, personal digital assistants (PDAs), and portable game devices; household electric appliances such as video cameras, liquid crystal televisions, and microwave ovens; in-vehicle devices such as back monitors, car navigation system monitors, and car audios; exhibition devices such as information monitors for commercial stores; security devices such as surveillance monitors; and nursing care and medical devices such as nursing-care monitors and medical monitors.

### EXAMPLES

Next, examples of the present invention will be described together with comparative examples. It is to be noted, however, that the present invention is by no means limited by the following examples and comparative examples. Various characteristics described in the respective examples and comparative examples were evaluated or measured by the following methods.

(1) Birefringence Δn

The birefringence Δn was measured using an Abbe refractometer (ATAGO CO., LTD., trade name “DR-M4”).

(2) Retardation Values (Re, Rth)

The retardation values (Re, Rth) were measured at a wavelength of 590 nm and at 23° C. using an “AXOSCAN (trade name)” manufactured by Axometrics, Inc.

(3) Average Tilt Angle (β)

The average tilt angle (β) was determined by substituting, na, nb, nc, and retardation values δ (retardation values measured at 5°-interval in the polar angle range from −50° to +50° (with the normal direction being 0°) in a direction perpendicular to the slow axis) to the formulae (I) and (II) shown above. The retardation values were measured at a wavelength of 590 nm and at 23° C. using an “AXOSCAN (trade name)” manufactured by Axometrics, Inc. The respective refractive indices were measured using an Abbe refractometer (ATAGO CO., LTD., trade name “DR-M4”).

(4) Front Contrast

Y-values in an XYZ-display system in a liquid crystal display displaying a white image and a black image were measured using a luminance meter (BM-5) manufactured by Topcon Corporation. Based on the Y-value obtained regarding the white image (YW: white luminance) and the Y-value obtained regarding the black image (YB: black luminance), the contrast ratio “YW/YB” in the front direction was calculated.

(5) Thickness

The thickness was measured using an “MCPD-3000 (trade name)” manufactured by Otsuka Electronics Co., Ltd.

### Example 1

A polycarbonate polymer (Tg=148° C.) was melt-extruded through a T-die heated at 280° C. (T1), and then passed between two rolls R1 and R2 heated at 160° C. (T2) and rotated at different rotational speeds (the rotational speed of one of the rollers was set to be 50% of the rotational speed of the other roller), thereby tilting the optical axis in the thickness direction. Thus, a film with a thickness of 150 μm was obtained. The temperature (T3) of the molten resin immediately before tilting the optical axis in the thickness direction was 245° C. Thereafter, the film was stretched to 1.5 times its original length at 155° C. (T4) by transverse uniaxial stretching (stretching in the width direction). In this manner, an optical compensation film with a thickness of 100 μm was obtained. Various characteristics of this optical compensation film were measured and found to be as follows: Δn=0.001, Re=100 nm, Rth=130 nm, and β=44°. This optical compensation film was laminated on a polarizer, and the resultant laminate was mounted in a 20 inch-TN mode liquid crystal display manufactured by SAMSUNG. As a result, the liquid crystal display was excellent in front contrast (1400) and viewing angle characteristics. Also, the uniformity in appearance of this liquid crystal display was as high as that of a liquid crystal display of Example 3 to be described below

### Example 2

Pellets of a polycarbonate (Tg=134° C.) were melt-extruded at 280° C. (T1), and then passed between two rolls R1 and R2 heated at 130° C. (T2) and rotated at different rotational speeds (the rotational speed of one of the rollers was set to be 10% of the rotational speed of the other roller), thereby tilting the optical axis in the thickness direction. Thus, a film with a thickness of 100 μm was obtained. The temperature (T3) of the molten resin immediately before tilting the optical axis in the thickness direction was 230° C. Thereafter, the film was stretched to 1.2 times its original length at 155° C. (T4) by transverse uniaxial stretching. In this manner, an optical compensation film with a thickness of 95 μm was obtained. Various characteristics of this optical compensation film were measured and found to be as follows: Δn=0.0014, Re=76 nm, Rth=134 nm, and β=33°. This optical compensation film was laminated on a polarizer and the resultant laminate was mounted in the same liquid crystal display as used in Example 1. As a result, the liquid crystal display was excellent in front contrast (1555) and viewing angle characteristics. Also, the uniformity in appearance of this liquid crystal display was as high as that of a liquid crystal display of Example 3 to be described below.

### Example 3

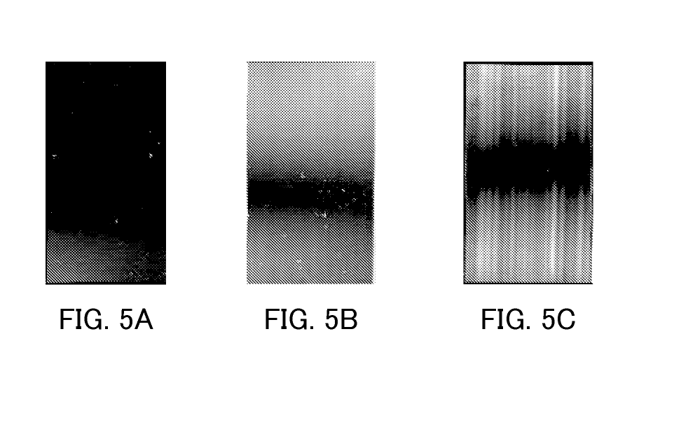

Pellets of a cyclic olefin polymer (Tg=133° C.) were melt-extruded at 265° C. (T1), and then passed between two rolls R1 and R2 heated at 105° C. (T2) and rotated at different rotational speeds the rotational speed of one of the rollers was set to be 3% of the rotational speed of the other roller), thereby tilting the optical axis in the thickness direction. Thus, a film with a thickness of 110 μm was obtained. The temperature (T3) of the molten resin immediately before tilting the optical axis in the thickness direction was 220° C. Thereafter, the film was stretched to 1.2 times its original length at 140° C. (T4) by transverse uniaxial stretching. In this manner, an optical compensation film with a thickness of 100 μm was obtained. Various characteristics of this optical compensation film were measured and found to be as follows: Δn=0.0012, Re=83 nm, Rth=112 nm, and β=40°. This optical compensation film was laminated on a polarizer, and the resultant laminate was mounted in the same liquid crystal display as used in Example 1. As a result, the liquid crystal display was excellent in front contrast (1400) and viewing angle characteristics. Also, as shown in FIG. 5A, the liquid crystal display was excellent in uniformity in appearance.

### Example 4

An optical compensation film was formed in the same manner as in Example 1, except that two rolls R1 and R2 heated at 40° C. (T2) were used. As a result, the optical compensation film with a thickness of 100 μm was obtained. Various characteristics of this optical compensation film were measured and found to be as follows: Δn=0.0014, Re=80 nm, Rth=131 nm, β=30°. This optical compensation film was mounted in the same liquid crystal display as used in Example 1. As a result, as shown in FIG. 5B, although minute stripes were seen in appearance, the liquid crystal display was excellent in front contrast (1386) and viewing angle characteristics, and had no problem from a practical standpoint.

### Comparative Example 1

An optical compensation film was formed in the same manner as in Example 1, except that the temperature (T3) of a molten resin immediately before tilting the optical axis in the thickness direction was set to 150° C. The optical compensation film was mounted in the same liquid crystal display as used in Example 1. As a result, as shown in FIG. 5C, poor appearance (stripes) occurred.

Various characteristics of each of the optical compensation films formed in the examples and comparative example were measured or evaluated. The results are shown in Table 1 below. In Table 1, “A” means that the obtained optical compensation film exhibited a favorable tilt with respect to the thickness direction (at least 30%) and showed a good appearance after the stretching (no stripe was observed). “B” means that the obtained optical compensation film had no problem from a practical standpoint, although minute stripes were observed after the stretching. “C” means that, after the stretching, distinct stripes were observed and poor appearance occurred.

TABLE 1

| | | | | | Relationship | |
|---|---|---|---|---|---|---|
| | | | | | between | |
| | Tg | T3 | T2 | T3 > T2 | Tg and T2* | Effect |
| Ex. 1 | 148° C. | 245° C. | 160° C. | satisfied | satisfied | A |
| Ex. 2 | 134° C. | 230° C. | 130° C. | satisfied | satisfied | A |
| Ex. 3 | 133° C. | 220° C. | 105° C. | satisfied | satisfied | A |
| Ex. 4 | 148° C. | 245° C. | 40° C. | satisfied | not satisfied | B |
| Comp. | 148° C. | 150° C. | 160° C. | not | satisfied | C |
| Ex. 1 | | | | satisfied | | |

*Relationship between Tg and T2: Tg − 70° C. < T2 < Tg + 15° C.

As can be seen from Table 1, Examples 1 to 3 provide optical compensation films that can realize excellent front contrast, viewing angle characteristics, and uniformity in appearance, when thy are mounted in a liquid crystal display. Also, Example 4 provides an optical compensation film having no problem from a practical standpoint, although it was slightly inferior to the optical compensation films Example 1 to 3 in terms of appearance. In contrast, Comparative Example 1 only could provide an optical compensation film causing poor appearance (stripes).

### INDUSTRIAL APPLICABILITY

According to the method for manufacturing an optical compensation film according to the present invention, it is possible to manufacture a novel tilt alignment type optical compensation film using a non-liquid crystal polymer material. The optical compensation film obtained by the present invention can be used suitably for image display devices such as LCD, for example. There is no limitation on the use of the optical compensation film, and the optical compensation film is applicable to a wide range of fields.

### Explanation of reference numerals

10, 10′: polarizer
20, 20′: optical compensation film
30: liquid crystal cell
100: optical compensation film-integrated polarizing plate
200: liquid crystal panel
R1, R2: roll

1. A method for manufacturing an optical compensation film comprising
melting a non-liquid crystal polymer to prepare a molten resin;
forming a film having an optical axis that tilts with respect to a thickness direction of the film by applying a shear force to the melted non-liquid crystal polymer by a shear force application device; and
stretching the film, wherein
the step of forming, the film is carried out under conditions where a temperature T3 of the melted non-liquid crystal polymer, a glass transition point Tg of the non-liquid crystal polymer, and a temperature T2 of the shear force application device satisfy relationships represented by the following formulae (A) and (B):
T3>Tg+25° C.; and (A)
T3>T2. (B)

2. The method according to claim 1, wherein
in the step of forming the film, the shear force is applied to the melted non-liquid crystal polymer by causing the melted non-liquid crystal polymer to pass between two rolls rotated at different rotational speeds, and
T2 is a temperature of one of the two rolls having a higher temperature.

3. The method according to claim 2, wherein
a ratio of the rotational speed of one of the two rolls to the rotational speed of the other roll is in a range from 0.1% to 50%.

4. The method according to claim 1, wherein
T2 satisfies a relationship represented by Tg−70° C.<T2<Tg+15° C.

5. The method according to claim 1, wherein
a stretching temperature T4 in the step of stretching the film satisfies a relationship represented by Tg≦T4<T3.

6. The method according to claim 1, wherein
in the step of stretching the film, the film is stretched at a stretch ratio in a range from 1.01 to 2.00 times.

7. The method according to claim 1, wherein
the optical compensation film satisfies the following formulae (1) and (2):
3 nm≦(nx−ny)×d≦200 nm (1)
5°<β (2)
where, in the formulae (1) and (2), among three refractive indices nx, ny, and nz respectively on X, Y, and Z, nx denotes a refractive index in a direction in which a refractive index within a film plane reaches its maximum; ny denotes a refractive index in a direction that is orthogonal to the direction of nx within the film plane; and nz denotes a refractive index in a thickness direction of the film, which is orthogonal to each of the directions of nx and ny, and d denotes a thickness (nm) of the film, and β denotes an angle formed by a direction of nb and the direction of ny, where nb is a maximum refractive index within an YZ plane of the film, which is orthogonal to the direction of nx.

8. The method according to claim 1, wherein the molten resin has a glass transition point (Tg) from 80° C. to 170° C.

9. The method according to claim 1, wherein the molten resin has a melting temperature from 180° C. to 300° C.

10. The method according to claim 1, Wherein the molten resin has a melt viscosity at a shear rate of 100 (1/s) of not more than 10000 Pa·s at 250° C.

11. The method according to claim 1, wherein the non-liquid crystal polymer has a photoelastic coefficient from 1×10⁻¹² to 9×10⁻¹¹ m²/N.

12. The method according to claim 1, wherein a temperature T1 of the molten resin during melt extrusion in the melting step and the temperature T2 satisfy a relationship represented by T1>T2.

13. The method according to claim 1, wherein a temperature T1 of the molten resin during melt extrusion in the melting step and the temperature T3 satisfy a relationship represented by T1>T3.

14. The method according to claim 13, wherein the temperatures T1 and T3 satisfy a relationship represented by T1>T3×1.1.
